(19) United States
(12) Patent Application Publication
(10) Pub. No.: US 2008/0255970 A1
(43) Pub. Date: Oct. 16, 2008

(54) Method, system,apparatus or device for providing reconciled bookkeeping or accounting electronically

(76) Inventor: Anthony John Ferguson, Sydney (AU)

Correspondence Address: Anthony John Ferguson, 5 Henry Street, Randwick, 2031, AU

(21) Appl. No.: 12/077,863

(22) Filed: Mar. 24, 2008

Related U.S. Application Data
(60) Provisional application No. 60/993,605, filed on Sep. 14, 2007.

(30) Foreign Application Priority Data
Apr. 10, 2007 (AU) 2007901881

(51) Int. Cl. G06Q 40/00

(52) U.S. Cl. 705/30

(57) ABSTRACT

A method for providing bookkeeping or accounting electronically. More particularly, this invention relates to a system or method for creating a reconciled set of electronic books by firstly introducing and integrating an accounting classification code or codes into the transaction data routinely captured by financial institutions at the time of the financial transaction to form a data aggregate on the financial institution server; the access by and transfer to the server of a person, business or entity, or a service provider authorised by the person, business or entity, of those data aggregates; the processing of that data into a form or state compatible with the operating requirements of a bookkeeping or accounting program used to prepare the financial records of the person, business or entity and the transfer of the processed data into the program ledger, journal or cash book to produce a set of electronic books for a period.

### FIELD OF THE INVENTION

This invention relates in general to a method, system and apparatus or device for providing bookkeeping or accounting electronically. More particularly, this invention relates to a system, method, apparatus and device for creating a reconciled set of electronic books by firstly introducing and integrating an accounting classification code or codes into the transaction data routinely captured by financial institutions at the time of the financial transaction to form a data aggregate on the financial institution server; the access by and transfer to the server of a person, business or entity, or a service provider authorised by the person, business or entity, of those data aggregates; the processing of that data into a form or state compatible with the operating requirements of a bookkeeping or accounting program used to prepare the financial records of the person, business or entity and the transfer of the processed data into the program ledger, journal or cash book to produce a set of electronic books for a period.

### BACKGROUND

Traditionally, people, businesses and other entities have received funds and paid expenses relating to transactions and obligations through an account predominantly managed by a bank or other financial institution (hereinafter a “Bank account”).

Each transaction is also, subsequently and/or separately, recorded into the entity's bookkeeping or accounting system that is generally maintained by a computer or server processing system by the person, business or entity or an authorised bookkeeping or accounting service provider. These transactions are entered into the bookkeeping or accounting system either wholly or partly by personal or intellectual means and represents a duplication of effort.

The bank or financial institution issues a monthly statement of bank account activity so that the books can be reconciled to the bank statement for the period.

It is time consuming, expensive and difficult to maintain and reconcile that bookkeeping or accounting system which, traditionally, has required a level of expertise in bookkeeping or accounting by the person, business or entity.

Many persons, businesses or entities, not having the time or requisite skills to maintain the bookkeeping or accounting system, choose to have the system maintained by bookkeeping or accounting service providers, which adds to costs and delays in reporting of trading results.

The financial transaction data currently captured and stored by financial institutions, not containing an accounting category classification code, is not in a form or state that is compatible with bookkeeping or accounting program system operational requirements.

With the increased use and popularity of the Internet, many people have sought a resolution to the problem of coding financial transactions with proposals that include, inter alia:
Downloading of bank account data in its current or “traditional” form and the application of category codes to the data after the download;
The coding of transactions through the use of such source document details a Standard Industry Codes (SIC's) and merchant codes—this information usually being sought from merchants subsequent to the actual transaction;
Proposals whereby other category classification is sought from source documentation and/or end users and intended for use by the inventor or inventors only.

All of the foregoing proposals or methods, however, contain one or more of the following limiting features:
They require varying degrees of accounting or bookkeeping skills;
They are either program specific or use by or for the inventing parties only;
Transactions can often be only broadly, not specifically, classified;
They are not able or intended to be used universally;
They introduce category classification codes only subsequent to a financial transaction; or
They do not permit specific classification of data, by the person conducting the financial transaction, at the time of the transaction.
They do not permit, or even canvass, the optional classification of data on behalf of a third party (payee or billing party) where such code or codes have been provided by the payee or billing party.

The present invention seeks to ameliorate one or more of the above-mentioned disadvantages.

### DEFINITIONS

Throughout this specification the following definitions shall apply:
Bank account—an account held by a person or entity at a financial institution or credit card provider.
Classification code—Numerical values denoting a category from a “Chart of Accounts” and includes a value denoting a “suspense” or quarantine category.
Bibliographic data—Information such as for example date, account number, party names, party reference numbers, cheque numbers and funds transferred relating to a transaction.
Data aggregate—Information including bibliographic data and classification codes.
Storage means—hard disk drive or other electronic data storage solution.
Server of a person, business or entity—should be read to include the server of bookkeeping or accounting service providers authorized by the person, business or entity to access data aggregates for the purpose of providing such bookkeeping or accounting services.

### SUMMARY OF THE INVENTION

According to one aspect of the present invention there is provided a method of conducting a financial transaction by a person, business or other entity, the method including the steps of: classifying a transaction into a class corresponding to an accounting code of a chart of accounts associated with the person, business or other entity; subsequently transferring a selected quantity of money to or from the bank account of the person, business or other entity.

According to another aspect of the present invention there is provided a method of conducting a financial transaction by a person, business or other entity, the method including the steps of: classifying a transaction into a class corresponding with an accounting code of a chart of accounts associated with another person, business or other entity, such code having been provided by that other person, business or other entity; subsequently transferring a selected quantity of money into the bank account of that person, business or other entity.

According to another aspect of the present invention there is provided a method of conducting a financial transaction in relation to a person, business or other entity, the method including the steps of: a financial institution classifying a transaction into an agreed class corresponding to an accounting code of a chart of accounts associated with the person, business or other entity in relation to financial institution initiated transactions such as account keeping fees, interest paid or received, merchant fees and the like and associated with the bank account; subsequently transferring a selected quantity of money to or from the bank account of the person, business or other entity

According to yet another aspect of the present invention there is provided a method of conducting a financial transaction in relation to a person, business or other entity, the method including the steps of: where a financial transaction has absent classification data, a financial institution classifying a transaction into an agreed quarantine class corresponding to an accounting code of a chart of accounts associated with the person, business or other entity; subsequently transferring a selected quantity of money to or from the bank account of the person, business or other entity

According to still another aspect of the present invention there is provided a method of preparing a statement of account for a bank account associated with a person, business or other entity, the method including the steps of: obtaining transaction data for the bank account; collating the transaction data into a selected order; wherein the transaction data includes classification data corresponding with selected accounting codes.

According to a still further aspect of the present invention there is provided a statement of transaction activity related to a bank account, the statement including: one or more transaction records assembled into a selected order, the or each transaction record including classification data corresponding with selected accounting codes

According to a yet further aspect of the present invention there is provided a method of preparing a statement of bank account transaction activity, the method including the steps of, in a computer processing system: obtaining transaction data from a storage means; wherein the transaction data includes classification data corresponding with selected accounting codes.

According to a yet further aspect of the present invention there is provided a method of conducting a financial transaction by persons, businesses or other entities, the method including the steps of, in a computer processing system: recording classification data corresponding with selected accounting codes; transferring a selected sum of money to or from a bank account.

According to a yet further aspect of the present invention there is provided a method of conducting a financial transaction by persons, businesses or other entities, the method including the steps of: recording bibliographic data relating to the transaction; recording classification data corresponding with a selected accounting code; associating the classification data with the bibliographic data.

According to a yet further aspect of the present invention there is provided a method of conducting a financial transaction by persons, businesses or other entities, the method including the steps of, in a computer processing system; recording bibliographic data relating to the transaction; recording classification data corresponding with selected accounting codes; associating the classification data with the bibliographic data to form a data aggregate.

Preferably the computer processing system includes a central processing unit, memory, storage means, input device, and output device. Optionally the computer processing system is connected to other computer processing systems and server processing systems via a communications network.

Preferably, the classification step includes classifying transactions into classes, such as for example: Income and Expenses, such as for example in the income class: Sales revenue, dividend income, net foreign income, interest, rents received and the like. On the expenses side, some examples include: telephone, rent, advertising, wages, bank fees, cleaning and the like.

Preferably the classification data, associated with the bibliographic data, is stored in the storage means.

Preferably the method includes an access step wherein the person, business or other entity, or authorized service provider, may access the data aggregate. In one form the access step includes a collating step where the data aggregate is collated with other data aggregates associated with the person, business or other entity for a period and arranged into a selected order and recorded on a statement, and stored in an electronic file. Preferably the access step also includes a transfer of data from the financial institution via the communications network to the server of the person, business or other entity.

Preferably the method includes a processing step wherein the data aggregates received from the financial institution at the access step are subjected to a sorting and collating process in a section of the server configured to accept the coded data aggregates.

Preferably the processing step further includes the sorting and collating of data aggregates into, say, classification code order accompanied by the other bibliographic data associated with each financial transaction; then date order within those classifications; any other sorting required for compatibility with different bookkeeping or accounting programs operational requirements.

Preferably the processing step includes the further step of identifying transactions with an absent or invalid classification code, or a quarantine code attached at the time of a transaction by a user or financial institution, and the isolating and quarantining of such transactions in a suspense account attached to the program for amendment before transfer to the program ledgers.

Preferably the method includes the transfer of the sorted and collated data aggregates into the bookkeeping or accounting program Ledgers.

Preferably the method includes a quarantine step wherein data aggregates with a faulty or absent classification data may be placed into a quarantine area, until the bibliographic data may be classified. The quarantine step preferably includes assigning a quarantine code to the bibliographic data at the processing step, and preferably storing the quarantined data. Preferably the quarantine code or codes correspond with a suspense account code or codes included in an accounting program chart of accounts.

Preferably the quarantine step further includes the recognition and transfer of data aggregates containing a quarantine code, inserted by a user or financial institution at the time of the financial transaction, into a quarantine area, until the bibliographic data may be classified.

Preferably the method includes an amendment step, the method including the steps of: identifying the appropriate classification code pertaining to a financial transaction that has been assigned to the quarantine area; classifying the transaction into a class corresponding with an accounting code of a chart of accounts associated with a person, business or other entity; transferring the amended data aggregates to the program ledgers.

Preferably the method includes a report confirming the reconciliation of bookkeeping or accounting program data with the bank account details

Preferably a deposit or payment form, on paper, Internet or other electronic device, is provided, which includes a classification prompt or space where a user enters relevant classification data along with other bibliographic data.

Preferably a deposit or payment form, on the Internet, telephone or other electronic device, is provided, which includes a classification prompt or space where a user may enter a third party or payee's relevant classification data along with other bibliographic data.

Preferably a person, business or other entity provides the user with a classification code associated with goods or services supplied by that other person, business or other entity so that the classification code may be entered at the time of conducting the electronic transaction

Preferably the method includes a conversion step where a user may input the bibliographic and classification data via a communications network such as for example a telephone handset (using a suitable protocol, Bluetooth, GSM mobile or landline), or the internet and the classification data is transferred to the computer processing system via DTMF tones or pulses, or via software or firmware coding.

### DESCRIPTION OF A PREFERRED EMBODIMENT

In order to enable a clearer understanding of the invention, drawings illustrating an example embodiment are attached, and in those drawings:

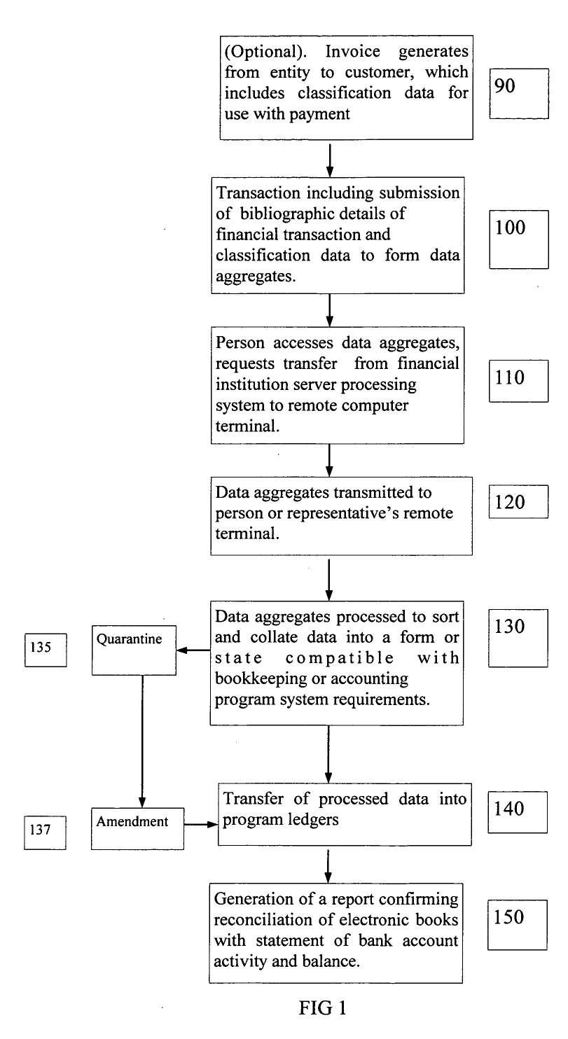

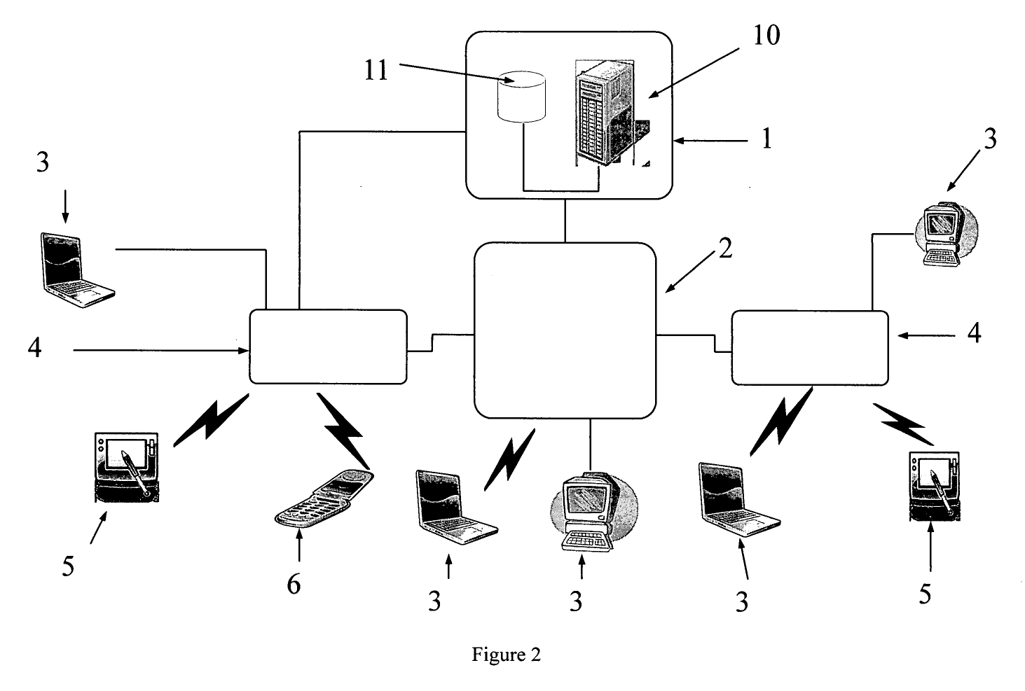

FIG. 1 is a flowchart of a method according to a preferred embodiment of the present invention;

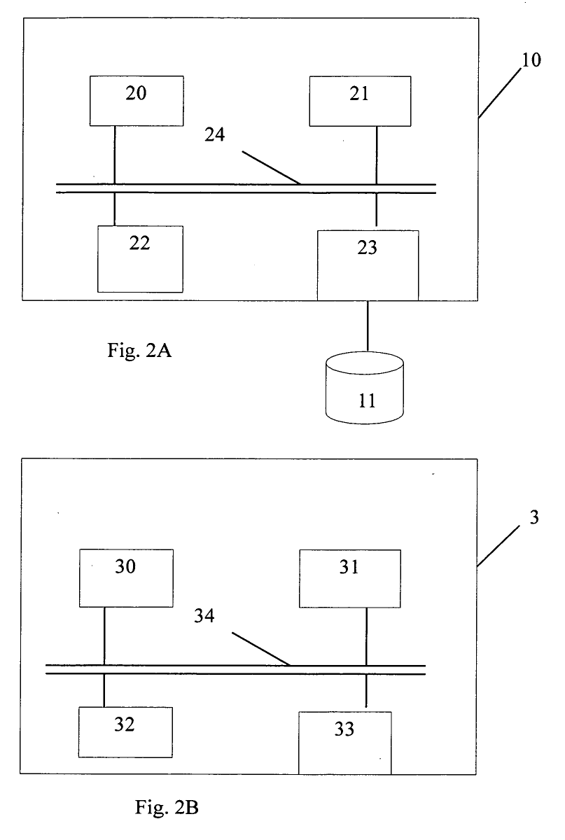

FIG. 2 is a schematic view of a computer processing system connected to a communications network which facilitates the preferred embodiments of the present invention;

FIG. 2A is a schematic view of a computer processing system;

FIG. 2B is a schematic view of an end station;

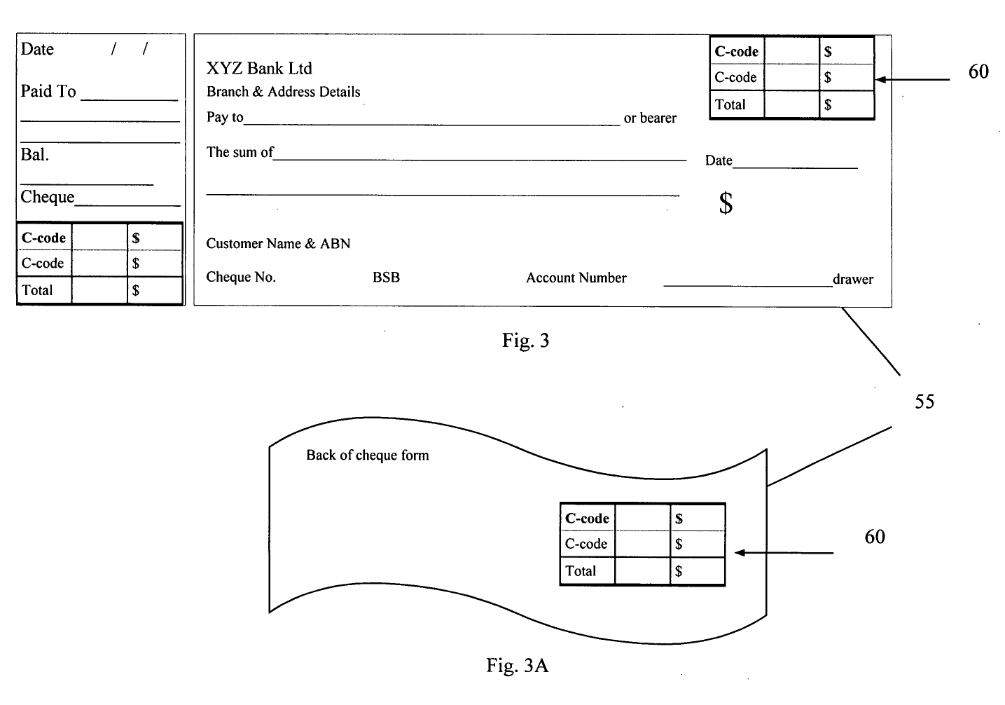

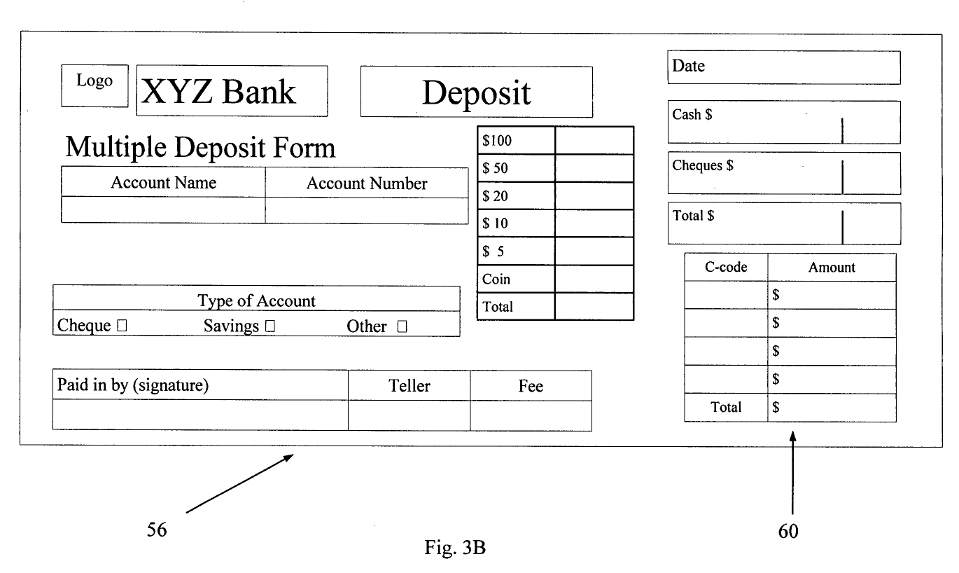

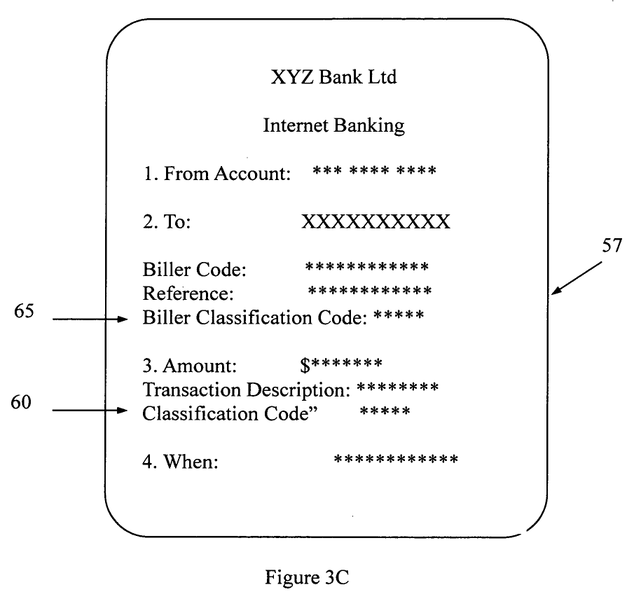

FIG. 3 is an example of a preferred embodiment of a form which prompts a user or customer to input classification data on a paper payment (cheque) form;

FIG. 3A is an example of a preferred embodiment of a form which prompts a user or customer to input classification data on the reverse side of a paper payment (cheque) form where regulatory provisions do not permit additions or alterations to existing cheque face formats;

FIG. 3B is an example of a preferred embodiment of a form which prompts a user or customer to input classification data on a funds deposit form;

FIG. 3C is an example of a typical on-line or electronic banking form which prompts a user to input bibliographic and classification data and also, optionally, classification data corresponding to a chart of accounts associated with another person, business or entity where such code has been provided by the billing party;

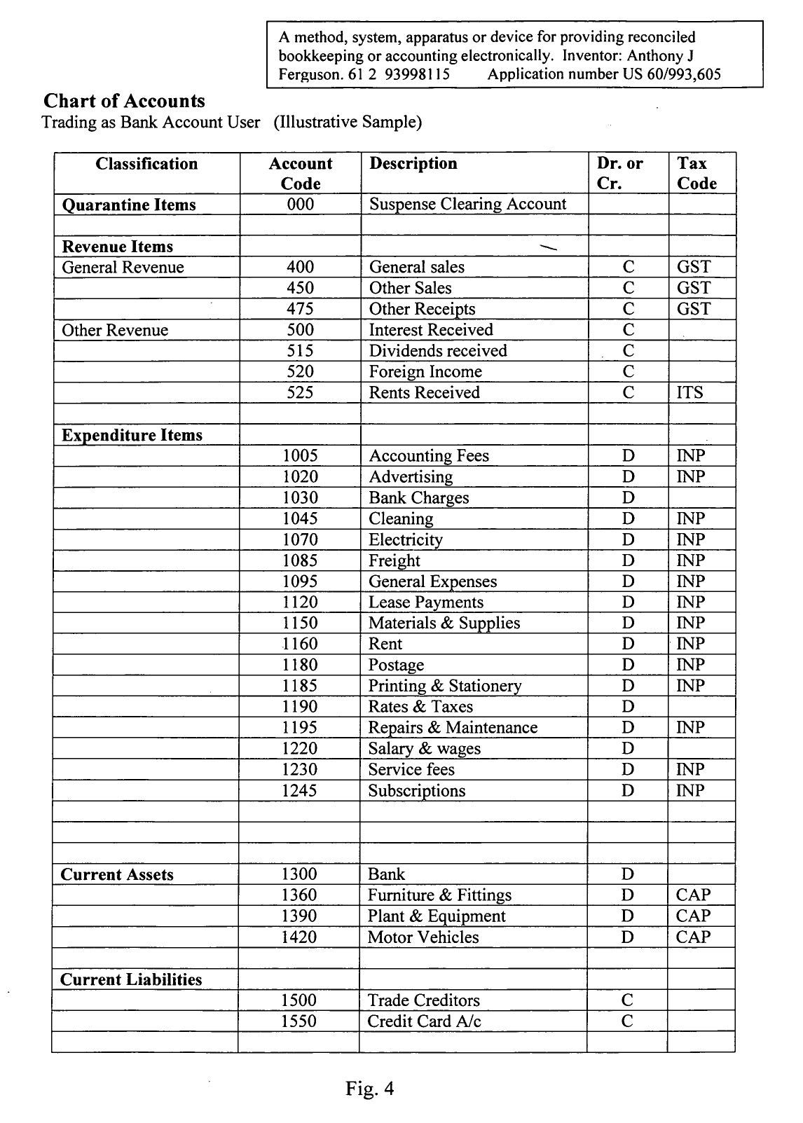

FIG. 4 is an example of classification data that may be required to add to bibliographic data during a transaction.

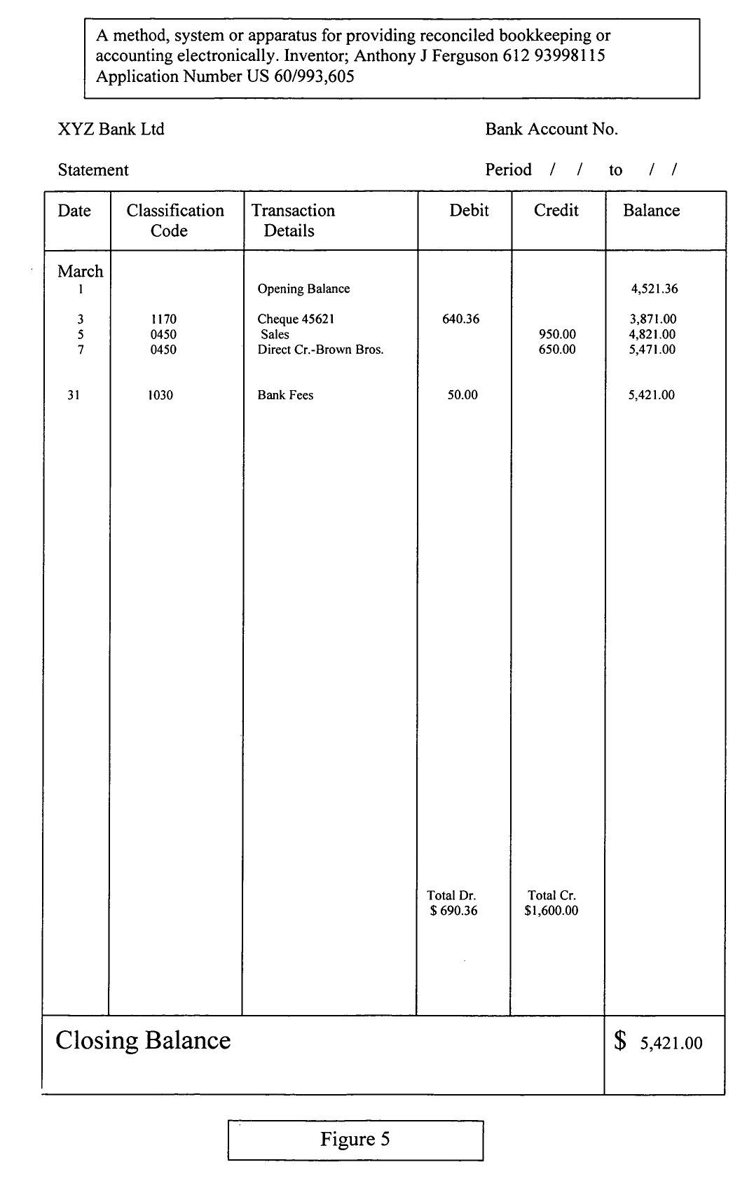

FIG. 5 is an example of a bank statement containing bibliographic and classification data.

### DETAILED DESCRIPTION OF A PREFERRED EMBODIMENT

Referring to the Figures there is shown an example of an architecture for communicating transaction data and data aggregates via a network.

As shown in FIG. 2 the architecture includes a base station 1 coupled to a number of end stations 3, 5, 6, via communications networks 2, 4. The communications networks 2, 4 may be communications networks such as telephone lines, the Internet, one or more Local Area Networks (LANs) one or more Wide Area Networks. (WANs), Wireless Networks such as the GSM, 3G or GPRS Network, or the like. The base station 1 and end stations 3, 5 and 6 typically include one or more processing systems 10, which may be coupled to a database 11, or the like, as shown.

In use, the end stations 3, 5, 6 are adapted to communicate with other end stations 3, 5, and 6. It will be appreciated that each of the end stations 3, 5 and 6 and the base station 1 are typically adapted to communicate via the communications networks, whilst the base station 1 is typically also adapted to provide routing type functionality. Accordingly, it will be appreciated that any form of suitable end station and base station may be used. An example of a processing system 10 is shown in FIG. 2A.

As shown the processing system 10 includes a processor 20, a memory and storage device 21, an input/output device 22, such as a keyboard and display or the like, and an external interface 23, coupled together via a bus 24. In use the external interface 23 may be coupled to the database 11, as well as providing connections to the communications networks 2, 4. Accordingly, the processing system 10 may be any form of processing system, such as a computer server, a network server, a web server, a desktop computer, a lap-top or the like. Alternative specialised hardware may be used.

Similarly, as shown in FIG. 2B, the end stations 3, 5 and 6 may be formed from a processor 30, a memory 31, an input/output device 32 and an external interface 33, coupled together via a bus 34. Again the external interface 33 may be used to provide a connection to the communications networks 2, 4.

Accordingly the end station 3, 5 and 6 may be any form of computer system such as a desktop computer, lap-top, specialised hardware or the like.

An example of a process for conducting a financial transaction utilising some, all or none of the abovementioned architecture will now be described with reference to FIG. 1.

Step 90 is an optional invoice step, wherein an invoice may be sent to a customer, wherein the invoice includes a classification code printed thereon, which may be transferred and associated with a customer's subsequent transaction upon payment of the invoice.

Step 100 is the classification step in which the transaction with the financial institution may be by either (a) a customer making payment for goods or services received directly to the bank account of a person, business or other entity, or (b) by a person, business or other entity making a deposit or payment via their or its own bank account.

In either instance, a form with bibliographic details of the transaction, either electronically via a handset or other input output device 22 or via a cheque form 55, deposit slip 56 or Internet banking form 57 shown at FIG. 3, 3A, 3B or 3C is utilised. The forms 55, 56 and 57 include a portion for classification data located at 60, where the customer records a relevant code selected from, say, a table shown at FIG. 4. A prompt may be utilised in telephone transactions, or on an online form 57 in Internet transactions. A further prompt 65 may be utilised in telephone or on an online form in Internet transactions to insert third party classification data shown at FIG. 3C.

A lookup table may be used when utilising the electronic input device so that, for example, the customer or data entry clerk may input a text string such as royalty income and the computer processing system matches the text string with a code. The code is input to a bank account file and the file is subsequently stored in the storage device.

The classification occurs at the time of conducting the transaction, so that the classification data is associated with bibliographic data of the transaction at the time of the transaction, not later, which tends to increase labour.

Step 10 is an access step where the customer or a client server processing system 3 requests that the financial institution's server transmit or transfer a copy of transaction data aggregates (bibliographic and classification data) to the client server processing system 3.

The data aggregates are transmitted at step 120 to the server processing system 3. This step 120 is conducted by a software module which causes data aggregates to be transferred into a program in the server processing system 3 for further processing

Step 130 is the processing step. In this step, the server processing system is configured to accept the coded data aggregates and process the data into a form or state compatible with the bookkeeping or accounting program system requirements. This would typically involve the sorting of the data aggregates into classification code order (together with associated bibliographic data), then date order within those classification codes in preparation for transfer of the data into program Ledgers.

The step 130 may be conducted by a stand-alone module or be incorporated into a bookkeeping or accounting software package as an option, and the step functionality may be purchased for an additional fee.

A quarantine step is provided at 135 wherein any data aggregate without any classification code, a quarantine code which has been inserted by a user or financial institution prior to this step, or having a code of incorrect syntax, are held for subsequent amendment at Step 137.

At step 140 the data aggregates, having been processed, sorted and collated into a form or state compatible with the bookkeeping or accounting program system requirements are transferred into the program ledgers. The transfer step 140 is relatively fast, because the classification data is present in the data aggregates and does not need to be investigated and classified.

Step 150 is a reporting step to confirm confirming the reconciliation of bookkeeping or accounting program data with bank account details and balance.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

### Copyright Statement

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

The claims defining the invention are as follows:

1. A method of providing electronic-enabled accounting or bookkeeping comprising the steps of:
(a) the inclusion of a classification category code or codes corresponding to an accounting code of a chart of accounts associated with a person, business or entity into a financial transaction, by a person, business or other entity, with a financial institution;
(b) on the server of a financial institution associated with a person, business or other entity the capture and electronic storage of classification data together with other bibliographical data associated with a financial transaction to form a data aggregate;
(c) on the server of a financial institution associated with a person, business or other entity the provision of an electronic bank or other financial institution statement containing the sum of data aggregates for a given period;
(d) on a communications network, the access of data aggregates associated with the person, business or other entity and stored on the server of a financial institution;
(e) on a communications network the transmittal of data aggregates associated with a person, business or other entity to the server of a person, business or other entity;
(f) in a person, business or other entity's processing system, the quarantine of data aggregates not in a form or state compatible for use with the system requirements of that servers accounting or bookkeeping program;
(g) in a person, business or other entity's processing system, the amendment of faulty or invalid data aggregates into a form or state compatible for use with the system requirements of that servers accounting or bookkeeping program;
(h) in a person, business or other entity's server processing system, the processing of data aggregates into a form or state compatible for use with the system requirements of that servers bookkeeping or accounting program;
(i)) in a person, business or other entity's server processing system, the transfer of the processed data aggregates into the server's bookkeeping or accounting program ledgers,
(j)) in a person, business or other entity's server processing system, the reconciliation of program data with bank account statement data and balances, and
(k) in a person, business or other entity's server processing system, the generation of reconciled accounting reports.

2. The method claimed in claim 1 comprising the further steps of a financial institution making provision on transaction forms for the insertion of a classification code or codes and the insertion of a classification code by a person, business or entity at the time of conducting the financial transaction.

3. The method claimed in 1 comprising the further optional step of the inclusion of a classification code or codes corresponding to a chart of accounts associated with another person, business or entity into a financial transaction by a person, business or other entity.

4. The method claimed at 1 comprising the steps of a financial institution making provision on transaction forms for the insertion of a classification code or codes associated with another person, business or entity, for example a payee or billing party, and the insertion of a third party classification code or codes by a person, business or other entity, at the time of the financial transaction.

5. The method claimed in 1 comprising the further step of a financial institution, on its server, applying an agreed and stored classification code to transactions initiated by the financial institution such as account keeping fees, merchant fees, interest paid or received and the like

6. The method claimed in claim 1 comprising the optional step of a financial institution, on its server, applying an agreed and stored quarantine classification code to transactions not allocated an accounting classification code at the time of the transaction by a person, business or other entity.

7. The method claimed in claim 1 comprising the further step of a financial institution capturing a classification code or codes along with other traditional bibliographical transaction data (account name, account number, date, dollar amounts and the like) to form a data aggregate associated with a person, business or other entity, on its server.

8. The method claimed in 1 comprising the further step of a financial institution electronically storing data aggregates associated with a person, business or other entity, on its server.

9. The method claimed in claim 1 comprising the step of a financial institution, on its server, making available data aggregates associated with a person, business or other entity for a given period for access and transmittal, via a communications network, to the server of a person, business or other entity.

10. The method claimed in claim 1 comprising the step of the server of a person, business or other entity accessing, via a communications network, data aggregates associated with a person, business or other entity and made available by the financial institution.

11. The method claimed in 1 comprising the step of the transmittal of, from the server of a financial institution, via a communications network, the accessed data aggregates for a given period to a server associated with the person, business or entity.

12. The method claimed in claim 1 comprising the step of on the server processing system of a person, business or other entity, the processing of the data aggregates received from the financial institution to sort those data aggregates into a specified order such as for example; coded classification code order with associated bibliographical data; then date order within those classification.

13. In the method in claim 1, on the server of a person, business or other entity, where a transaction forming part of the accessed data aggregates has an absent, or invalid, classification code attached at the time of the transaction, the processing step will include the further step of identifying and quarantining the transaction in a suspense account attached to the bookkeeping or accounting program for amendment before transfer to the program ledger.

14. In the method at claim 1, on the server of a person, business or other entity, where a transaction has had a quarantine classification code inserted at the time of the transaction, the processing step will include the additional step of quarantining the transaction into a suspense account for amendment before transfer to the program ledger.

15. In the method claimed at claim 1, on the server of a person, business or other entity, the transfer of processed data into the bookkeeping or accounting program ledgers codes, for use with the server's accounting or bookkeeping program

16. In the method at claim 1, on the server of a person, business or other entity, the transfer of amended data aggregates into the accounting or bookkeeping program ledgers.

17. The method in claim 1 comprising the step of, on the server of a person, business or other entity, the generation of a report from within the bookkeeping or accounting program to confirm the reconciliation of the program data with bank statement activity statement and balance.

18. The method in claim 1 comprising the step of, on the server of a person, business or other entity the production of a set of reconciled electronic books for a period.
